(19) United States
(12) Patent Application Publication
(10) Pub. No.: US 2022/0099799 A1
(43) Pub. Date: Mar. 31, 2022

(54) TRANSFORMING MEASURED DATA BETWEEN VARIOUS CONFIGURATIONS OF MEASURING SYSTEMS

(71) Applicant: Robert Bosch GmbH, Stuttgart (DE)

(72) Inventors: Andrej Junginger, Stuttgart (DE); Thilo Strauss, Ludwigsburg (DE)

(21) Appl. No.: 17/448,270

(22) Filed: Sep. 21, 2021

(30) Foreign Application Priority Data
Sep. 30, 2020 (DE) 102020212366.7

(51) Int. Cl. G01S 7/41; G01S 13/42; G01S 13/58; G06N 20/00

(52) U.S. Cl. CPC G01S 7/41; G06N 20/00; G01S 13/58; G01S 13/42

(57) ABSTRACT

A method for ascertaining a transformation, which converts source measured data recorded using a source configuration of a measuring system at a scenery, into target measured data, which a target configuration of the measuring system would record at the same scenery. In the method: training source measured data recorded using the source configuration at training sceneries are provided; an approach is predefined, according to which the target measured data result from the source measured data by application of predefined filter operation(s) to the source measured data; the training source measured data are mapped by application of the filter operation on target measured data; the trainable model is trained with the goal of bringing the resulting filter operation, and/or the target measured data generated thereby into harmony with a predefined piece of additional information and/or condition; the approach completed by the trained model is provided as the sought-after transformation.

### CROSS REFERENCE

The present application claims the benefit under 35 U.S.C. 119 of German Patent Application No. DE 102020212366.7 filed on Sep. 30, 2020, which is expressly incorporated herein by reference in its entirety.

### FIELD

The present invention relates to the conversion of measured data of one scenery into measured data which another configuration of the measuring system used would record on the same scenery.

### BACKGROUND INFORMATION

In order that a vehicle may move in an at least semi-automated manner in road traffic, it is necessary to detect the surroundings of the vehicle and initiate countermeasures if a collision with an object in the surroundings of the vehicle is imminent. Creating a surroundings representation and locality determination are also required for safe automated driving. To detect the surroundings in the form of measured data, for example, cameras or radar sensors may be used.

Trained machine learning models, such as neural networks, may provide an essential contribution here in particular for object recognition. To train these models, training data are required, which are often recorded on test drives and are subsequently annotated (“labeled”) using the objects actually contained in the particular observed scenery. The labeling requires a large amount of manual work and is accordingly expensive. The labels are linked to the configuration used of the measuring system.

German Patent Application NO. DE 10 2018 204 494 B3 describes a generator, using which a fixed supply of training data may be expanded by synthetic radar data.

### SUMMARY

Within the scope of the present invention, a method is provided for ascertaining a transformation which converts source measured data F, which were recorded using a source configuration of a measuring system at a scenery, into target measured data F′, which a target configuration of the measuring system would record at the same scenery.

The measured data may be provided in particular, for example, in the form of image data. Image data generally associate one or multiple measured values (for example an intensity) with each location in a two-dimensional or multidimensional grid. The grid also defines a proximity between locations. However, the measured data may also be provided as point clouds, for example. A point cloud also associates one or multiple measured values with locations in a two-dimensional or multidimensional space. However, these locations are not situated in a grid. A point cloud is therefore an unordered list of locations in space which are each provided with measured values.

In particular radar data and LIDAR data may often alternately be expressed as image data or as point clouds.

The measured data may be in particular, for example, camera images, video images, radar data, LIDAR data, and/or ultrasonic images. The measured data may have resulted due to arbitrary preprocessing from the raw data supplied by the particular sensors. Thus, for example, radar data, which fluctuate spatially and over time, are converted into a spatially discrete distribution of probabilities that radar radiation was reflected from specific locations. This distribution may also be combined, for example, with further location-dependent distributions, for example of signal strengths, distances to objects, velocities of objects, and reflection angles, to form a data tensor.

The measured data may each be obtained by a physical measuring process, but also, for example, by a simulation of a physical measuring process. Furthermore, for example, a generator of a generative adversarial network (GAN) may be trained on the basis of measured data obtained by physical measurement using a configuration of a measuring system to generate realistic measured data from the same domain.

The source configuration and the target configuration of the measuring system may differ, for example, in the positions at which a sensor for the observation of the scenery is attached. In the case of radar sensors attached in a concealed manner, for example, the configuration of screening materials attached between the sensor and the scenery may also change. The sensor itself may also be replaced, for example, with a sensor of a new type.

The method is data-based. That means, training source measured data \tilde{F}, which were recorded using the source configuration of the measuring system at training sceneries, are provided.

An approach is predefined, according to which target measured data F′ result from source measured data F by application of at least one predefined filter operation Δ to source measured data F. This predefined filter operation Δ is in turn dependent via a trainable model on source measured data F to which it is to be applied.

The consideration behind this is that target measured data F′ still represent the same scenery as source measured data F. As a result, target measured data F′ should reasonably be a modification of source measured data F in which the essential contents of source measured data F are still recognized. For example, if an object is identified in source measured data F, it should also still be represented in target measured data F′. If the velocity of an identified object is also coded in source measured data F, for example, this velocity is also not to change excessively strongly upon the transition to the new configuration of the measuring system, because the observation of the object using the changed measuring system has no physical influence on its kinematics.

Therefore, target measured data F′ are sought from the beginning, whose changes in relation to source measured data F are “small.” Similarly to a series development of a function in surroundings of a point, target measured data F′ may thus be written as

F′=F+Φ=F×(1+Φ/F)=F×φ

where φ=1+Φ/F. The change may thus alternately be expressed as additive correction Φ or as multiplicative correction φ. This may also be further generalized to

F′=F⊗Δ(F),

in which Δ(F) is the filter function dependent on source measured data F and ⊗ is the application of this filter function Δ(F) to F. A filter function may be understood in particular, for example, as a function which associates locations in a multidimensional space to which target measured data F′ refer, on the basis of source measured data F with one or multiple locations of a tensorial function value.

To train filter operation Δ(F) in a data-based manner, training source measured data \tilde{F} are each mapped by application of filter operation Δ(\tilde{F}) on target measured data F′. The trainable model is trained with the goal of bringing filter operation Δ resulting therefrom, and/or target measured data F′ generated thereby into harmony with a piece of specified additional information and/or condition. After this training, the approach completed by the trained model is provided as the sought-after transformation.

Filter operation Δ(F) may be understood in the broadest meaning, for example, as a “field,” which associates a unique value with each position in source measured data F, according to which source measured data F are to be transformed during the transformation to target measured data F′.

It has been recognized that the targeted search for a trainable model which ultimately only effectuates a comparatively small change of source measured data F is significantly more efficient than a completely unconditional and open search for a transformation which results in target measured data F′. Thus, for example, each implementation of a machine learning method in a neural network has a certain power in the form of complexity and number of optimizable parameters, which may be established, for example, by the hardware resources (in particular GPU memory) available in the specific application. In the case of the open search for the transformation, which results in a complete regeneration of target measured data F′, a large amount of this power already has to be applied to simulating the basic properties which are already known from source measured data F. This means that a piece of already provided information is not used, but rather is cumbersomely recalculated. In contrast, if a small correction is deliberately sought after, all of the power of the neural network may be used in the search for this correction. Furthermore, the training converges better since the properties to be learned are “small” by design.

The useful application of the conversion described here of source measured data F into target measured data F′ is in particular, for example, that existing training images for systems which further evaluate the measured data may still be used after the change from the source configuration to the target configuration of the measuring system. For example, an image classifier or a system for the semantic segmentation of images is generally trained in a “monitored” manner. That means, training images are processed for which labels are available as to which objects the images show or which image pixels are associated with which object type, and the learning process is checked on the basis of these labels. As mentioned at the outset, these labels are linked to the configuration of the measuring system using which the training images were detected. To train or retrain the downstream evaluation after a change of the configuration, new labeled training images are necessary. Recording completely new training images using the changed configuration and especially labeling these new training images require significant effort, which in the extreme case may even have the result that an intended change of the configuration may not be carried out in a cost-effective manner. However, if already labeled source image data F may be transformed into target image data F′, not only is the effort for detecting new training images dispensed with, but rather the already provided labels may also still be used at least in large part. Therefore, the previous binding of labels to a specific configuration of the measuring system is no longer an impediment for a further development of this configuration.

The trainable model may be implemented in particular, for example, as a neural network. Such a neural network may include in particular, for example, multiple convolution layers, which each apply one or multiple filter cores to their particular inputs. For example, the neural network may include an encoder-decoder structure, in which an encoder generates a compressed representation of the input and the decoder generates the output therefrom. Direct connections may also be provided between convolution layers of the encoder and convolution layers of the decoder, due to which the encoder-decoder structure becomes a so-called “U-net.”

The described approximation that the change of target measured data F′ is “small” in relation to source measured data F is applicable in particular for smaller modifications of the configuration. One example of such a smaller modification is a lateral offset of a sensor at a vehicle, so that it detects the scenery from a slightly changed viewing angle. A further example of a smaller modification is the concealed attachment of a radar sensor behind a manufacturer emblem, which is placed for aesthetic reasons and for reasons of space. Emblems of various manufacturers have different thicknesses and material compositions, so that the signals emitted and received by the radar sensor are attenuated to different degrees. The angle dependence of the detection sensitivity may also be different, for example, after a replacement of one sensor with another sensor.

In particular in the development of measuring systems for detecting the surroundings of vehicles, there is frequently the desire to offset a sensor laterally or replace it with a sensor to optimize the detection on a specific aspect. Furthermore, the same measuring system may be sold, for example, to different vehicle manufacturers and combined there with different manufacturer emblems.

The approximation of a “small” modification is fulfilled in particular, for example, in one advantageous embodiment in which source measured data F and target measured data F′ are tensors and in which filter operation Δ changes the elements of target measured data F′ in comparison to source measured data F by at most 10% in absolute value.

Filter operation Δ may be predefined in particular, for example, as a parameterized function and the parameters of this function may be obtained from the trainable model. In this way, the output of the trainable model, which is typically provided in the form of numbers, in particular in the case of an implementation in a neural network, may be converted into actions, thereby changing source measured data F.

Diverse pieces of additional information or conditions may be used individually or in combination to obtain feedback for the training of the trainable model.

Thus, for example, the trainable model may be trained with the goal that filter operation Δ(F), at least for certain support points F₁, . . . , Fₙ, corresponds to predefined filter operations Δ_{T} (F₁, . . . , Fₙ). This may be reasonable, for example, if filter operation Δ_{T}(F₁-Fₙ) is already known from measurements using another measurement method. Furthermore, for example, a predefined filter operation Δ may be established at least qualitatively in such a way that its application ⊗ to source measured data F is invertible. For arbitrary source measured data F, Δ_{T}(F) may be calculated by

Δ_{T}(F)=F′⊗⁻¹F,

in which ⊗⁻¹ is the inverse filter application. The correspondence of Δ(F₁, . . . , Fₙ) to Δ_{T} (F₁, . . . , Fₙ) may be measured, for example, via a contribution

L=∥Δ(F)−Δ_{T}(F)∥

to the cost function (loss function) of the training. Therein, ∥ ∥ is a suitable norm or another differentiable function.

Alternatively or also in combination therewith, the trainable model may be trained, for example, with the goal that the dependence of target measured data F′ on source measured data F corresponds as well as possible to the predefined approach. Even if filter operation Δ is not invertible, in this way it is possible to monitor in a self-consistent manner to what extent the trainable model learns the correct relationship between F′ and F. This may be measured, for example, via a contribution

L=∥F′−F⊗Δ(F)∥

to the cost function of the training.

Alternatively or also in combination therewith, the trainable model may be trained, for example, with the goal that target measured data F′ correspond as well as possible to predefined training target measured data \tilde{F}. Thus, for example, if “ground truth” is available from further measurements regarding how target measured data F′ should appear, this information may also be used for checking the learning process. For example, if a further sensor observes the scenery from the same perspective as the measuring system does in the target configuration, this further sensor is to recognize objects, for example, approximately at the same positions as the measuring system. Therefore, training target measured data \tilde{F}′ are advantageously each selected which would be recorded using the target configuration at the measuring system on the same training sceneries as the training source measured data \tilde{F}.

In one particularly advantageous embodiment, a filter operation Δ is selected which generates target measured data F′ having the same compilation of objects which is contained in source measured data F. This reflects that ultimately the same physical scenery is observed using both configurations of the measuring system. Furthermore, the target configuration of the measuring system is not so drastically modified in relation to the source configuration that specific objects in one of the configurations do not show any contrast at all. Rather, the transformation is primarily intended for smaller modifications, for which the approximation mentioned at the outset of a “small” change of target measured data F′ in relation to source measured data F also applies.

According to the description above, in particular source measured data F are advantageously selected which were recorded using at least one radar sensor and indicate at least locations and velocities of objects which have reflected radar radiation to the radar sensor. The registered signal strength may significantly change here, for example, due to a sensitivity of the sensor, which is possibly also changed depending on angle, or also due to attenuation of the emitted and/or received radar signals, although the same objects are still detected as before.

Filter operation Δ may be further located in this embodiment, for example, in such a way that it leaves the velocities of objects unchanged in absolute value. In contrast, the directions of these velocities may change, for example, due to a spatial perspective changed in the target configuration.

According to the description above, the present invention also relates to a method for translating source measured data F, which were recorded using a source configuration of a measuring system at a scenery, into target measured data F′, which a target configuration of the measuring system would record at the same scenery. In this method, using the above-described method, a transformation of source measured data F recorded using the source configuration to target measured data F′ recorded using the target configuration is ascertained. Source measured data F are supplied to this transformation so that target measured data F′ are obtained.

In this case, for example, in particular the data sets of source measured data F may each be provided with labels on which a trainable classifier, such as an image classifier, or a system for semantic segmentation is to map each of these source measured data F. Each data set of target measured data F′ may then be associated with one or multiple labels L of that data set of source measured data F from which it was generated. A classifier or a system for semantic segmentation may then be trained in a monitored manner using target measured data F′ and labels L associated therewith.

The present invention may be represented in software, for example. The present invention therefore also relates to a computer program including machine-readable instructions which, when they are executed on one or multiple computer(s), prompt the computer or computers to carry out one of the described methods. In this meaning, control units for vehicles and embedded systems for technical devices which are also capable of carrying out machine-readable instructions are also to be considered to be computers.

The present invention also relates to a machine-readable data medium and/or to a download product including the computer program. A download product is a digital product transferable via a data network, i.e., downloadable by a user of the data network, which may be offered for sale in an online shop, for example, for immediate download.

Furthermore, a computer may be equipped with the computer program, with the machine-readable data medium, or with the download product.

Further measures improving the present invention are described in greater detail hereinafter together with the description of the preferred exemplary embodiments of the present invention on the basis of figures.

### BRIEF DESCRIPTION OF THE DRAWINGS

FIG. 1 shows an exemplary embodiment of method 100 for ascertaining a transformation 6 from source measured data F to target measured data F′, in accordance with the present invention.

FIG. 2 shows an exemplary embodiment of method 200 for translating source measured data F to target measured data F′, in accordance with the present invention.

FIG. 3 shows an exemplary application of method 200 on radar data, in accordance with the present invention.

### DETAILED DESCRIPTION OF EXAMPLE EMBODIMENTS

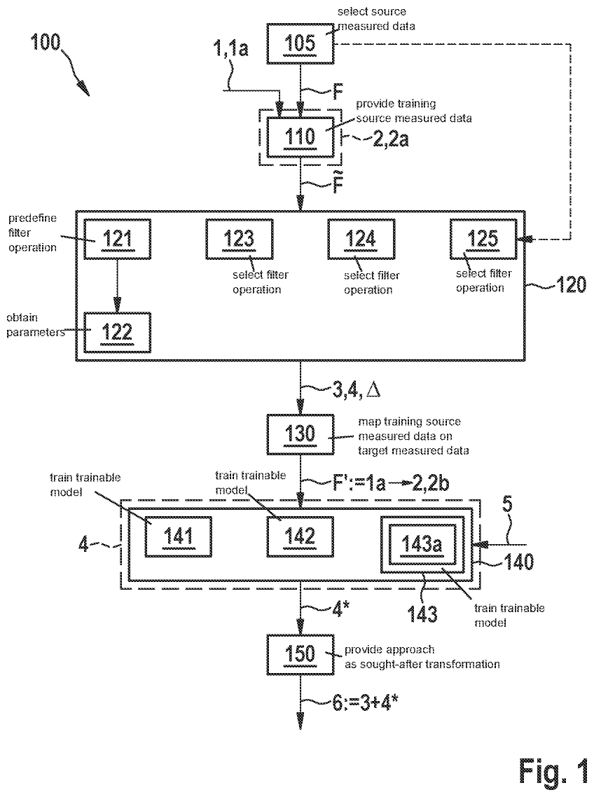

FIG. 1 is a schematic flowchart of an exemplary embodiment of method 100. A transformation 6 is ascertained using method 100. This transformation 6 may in turn be used to convert source measured data F, which were recorded using a source configuration 2a of a measuring system 2 at a scenery 1, into target measured data F′, which a target configuration 2b of measuring system 2 would record at the same scenery 1.

In step 110, training source measured data \tilde{F}, which were recorded using source configuration 2a of measuring system 2 at training sceneries 1a, are provided.

In step 120, an approach 3 is predefined, according to which target measured data F′ result from source measured data F by application of at least one predefined filter operation Δ to source measured data F. This predefined filter operation Δ is in turn dependent via a trainable model 4 on source measured data F, to which it is to be applied. Filter operation Δ may thus be written as Δ(F).

According to block 121, filter operation Δ may be predefined, for example, as a parameterized function. According to block 122, the parameters of this function may be obtained from trainable model 4.

According to block 123, for example, a filter operation Δ may be selected which generates target measured data F′ including the same compilation of objects which is contained in source measured data F.

According to block 124, source measured data F and target measured data F′ may be tensors, for example. A filter operation Δ may then be selected which changes the elements of target measured data F′ by at most 10% in absolute value in comparison to source measured data F.

According to block 105, source measured data F may be selected which were recorded using at least one radar sensor. According to block 125, for example, a filter operation Δ may be selected which leaves the velocity of objects unchanged in absolute value.

In step 130, training source measured data \tilde{F} are each mapped on target measured data F′ by application of the filter operation Δ(\tilde{F}). These target measured data F′ each indicate how target configuration 2b of measuring system 2 would have seen particular training scenery 1a, at which source measured data F were recorded using source configuration 2a of measuring system 2.

In step 140, trainable model 4 is trained with the goal of bringing filter operation Δ resulting therefrom, and/or target measured data F′ generated thereby into harmony with a predefined piece of additional information and/or condition 5. The finished trained state of trainable model 4 is denoted by reference numeral 4*.

Various examples of pieces of additional information and/or conditions 5 are indicated within box 140.

According to block 141, trainable model 4 may be trained, for example, with the goal that filter operation Δ(F), at least for specific support points F₁, . . . , Fₙ, corresponds to predefined filter operations Δ_{T}(F₁, . . . , Fₙ).

According to block 142, trainable model 4 may be trained, for example, with the goal that the dependence of target measured data F′ on source measured data F corresponds as well as possible to predefined approach 3.

According to block 143, trainable model 4 may be trained, for example, with the goal that target measured data F′ correspond as well as possible to predefined training target measured data \tilde{F}′. In particular, for example, according to block 143a, training target measured data \tilde{F}′ may be selected which would each be recorded using target configuration 2b of measuring system 2 at the same training sceneries la as training source measured data \tilde{F}.

In step 150, approach 3, which is completed by finished trained model 4*, is provided as sought-after transformation 6.

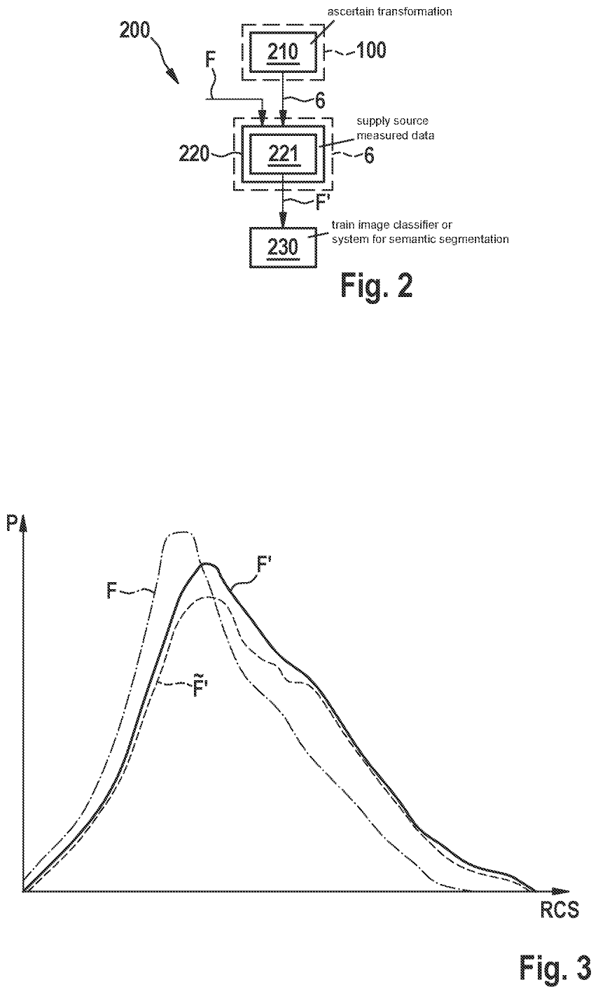

FIG. 2 is a schematic flowchart of an exemplary embodiment of method 200 for translating source measured data F to target measured data F′. In step 210, using above-described method 100, a transformation 6 of source measured data F recorded using source configuration 2a to target measured data F′ recorded using target configuration 2b is ascertained. In a step 220, source measured data F are supplied to this transformation 6 so that target measured data F′ are obtained.

For this purpose, the data sets of source measured data F, thus, for example, individual images or image tensors, may each be provided with labels L, on which a trainable image classifier or a system for semantic segmentation is to map each of these source measured data F. According to block 221, for example, each data set of target measured data F′ may be associated in each case with one or multiple labels L of that data set of source measured data F from which it was generated. In step 230, an image classifier or a system for semantic segmentation may be trained in a monitored manner using target measured data F′ and labels L associated therewith.

FIG. 3 shows an exemplary application of method 200 to radar data as source measured data F. For illustration, the radar data in FIG. 3 were summarized to form a distribution of frequencies P of specific values of the radar cross section (RCS).

Source measured data F were recorded using a first radar sensor. These source measured data F were transformed using method 200 to target measured data F′, which a second radar sensor would have detected at the same scenery. In the experiment shown in FIG. 3, this radar sensor was actually available and was used to record setpoint target measured data \tilde{F}′, on which method 200 is to have mapped source measured data F. There is a good correspondence in large part.

What is claimed is:

1. A method for ascertaining a transformation, which converts source measured data, which were recorded using a source configuration of a measuring system at a scenery, into target measured data, which a target configuration of the measuring system would record at the same scenery, the method comprising the following steps:
providing training source measured data, which were recorded using the source configuration of the measuring system at training sceneries;
predefining an approach according to which the target measured data result from the source measured data by application of at least one predefined filter operation to the source measured data, the predefined filter operation being dependent via a trainable model on the source measured data, to which it is to be applied;
mapping the training source measured data by application of the filter operation on target measured data;
training the trainable model with a goal of bringing the filter operation resulting therefrom, and/or the target measured data generated thereby into harmony with a piece of predefined additional information and/or condition;
providing the approach completed by the trained model as a sought-after transformation.

2. The method as recited in claim 1, wherein the filter operation is predefined as a parameterized function and wherein the parameters of the function are obtained from the trainable model.

3. The method as recited in claim 1, wherein a neural network is selected as the trainable model for the dependence of the filter operation on the source measured data.

4. The method as recited in claim 1, wherein the trainable model is trained with a goal that the filter operation corresponds, at least for specific support points to predefined filter operations.

5. The method as recited in claim 1, wherein the trainable model is trained with a goal that the dependence of the target measured data on the source measured data corresponds as well as possible to the predefined approach.

6. The method as recited in claim 1, wherein the trainable model is trained with a goal that the target measured data correspond as well as possible to predefined training target measured data.

7. The method as recited in claim 6, wherein training target measured data are selected, which were each recorded using the target configuration of the measuring system at the same training sceneries as the training source measured data.

8. The method as recited in claim 1, wherein the filter operation is selected, which generates target measured data including the same compilation of objects which is contained in the source measured data.

9. The method as recited in claim 1, wherein the source measured data are selected, which were recorded using at least one radar sensor, and the source measured data at least indicate locations and velocities of objects which have reflected radar radiation to the radar sensor.

10. The method as recited in claim 9, wherein a filter operation is selected, which leaves the velocities of objects unchanged in absolute value.

11. The method as recited in claim 1, wherein the source measured data and the target measured data are tensors and a filter operation is selected, which changes elements of the target measured data by at most 10% in absolute value in comparison to the source measured data.

12. A method for translating source measured data, which were recorded at a scenery using a source configuration of a measuring system, into target measured data, which were recorded using a target configuration of the measuring system at the same scenery, the method comprising:
ascertaining a transformation of source measured data recorded using the source configuration to target measured data recorded using the target configuration, the ascertaining including:
providing training source measured data, which were recorded using the source configuration of the measuring system at training sceneries,
predefining an approach according to which the target measured data result from the source measured data by application of at least one predefined filter operation to the source measured data, the predefined filter operation being dependent via a trainable model on the source measured data, to which it is to be applied,
mapping the training source measured data by application of the filter operation on target measured data,
training the trainable model with a goal of bringing the filter operation resulting therefrom, and/or the target measured data generated thereby into harmony with a piece of predefined additional information and/or condition,
providing the approach completed by the trained model as a sought-after transformation; and
supplying the source measured data to the sought-after transformation so that the target measured data are obtained.

13. The method as recited in claim 12, wherein:
data sets of the source measured data are each provided with labels, on which a trainable classifier or a system for semantic segmentation is to map each of the source measured data;
each data set of the target measured data is associated with one or multiple labels of that data set of the source measured data from which it was generated; and
the classifier or the system for semantic segmentation is trained in a monitored manner using the target measured data and the labels associated with the target measured data.

14. A non-transitory machine-readable data medium on which is stored a computer program for ascertaining a transformation, which converts source measured data, which were recorded using a source configuration of a measuring system at a scenery, into target measured data, which a target configuration of the measuring system would record at the same scenery, the computer program, when executed by one or more computers, causing the one or more computers to perform the following steps:
providing training source measured data, which were recorded using the source configuration of the measuring system at training sceneries;
predefining an approach according to which the target measured data result from the source measured data by application of at least one predefined filter operation to the source measured data, the predefined filter operation being dependent via a trainable model on the source measured data, to which it is to be applied;
mapping the training source measured data by application of the filter operation on target measured data;
training the trainable model with a goal of bringing the filter operation resulting therefrom, and/or the target measured data generated thereby into harmony with a piece of predefined additional information and/or condition;
providing the approach completed by the trained model as a sought-after transformation.

15. A computer configured to ascertain a transformation, which converts source measured data, which were recorded using a source configuration of a measuring system at a scenery, into target measured data, which a target configuration of the measuring system would record at the same scenery, the computer configured to:
provide training source measured data, which were recorded using the source configuration of the measuring system at training sceneries;
predefine an approach according to which the target measured data result from the source measured data by application of at least one predefined filter operation to the source measured data, the predefined filter operation being dependent via a trainable model on the source measured data, to which it is to be applied;
map the training source measured data by application of the filter operation on target measured data;
train the trainable model with a goal of bringing the filter operation resulting therefrom, and/or the target measured data generated thereby into harmony with a piece of predefined additional information and/or condition;
provide the approach completed by the trained model as a sought-after transformation.
